(19) United States
(12) Patent Application Publication
(10) Pub. No.: US 2022/0135918 A1
(43) Pub. Date: May 5, 2022

(54) METHOD OF PRODUCING A SPIRIT USING ONE OR MORE WOOD PIECE FOR IN-BOTTLE ENHANCING

(71) Applicant: James Joseph Sanctified Spirits, LLC, Westlake, TX (US)

(72) Inventor: Joseph Giildenzopf, Westlake, TX (US)

(21) Appl. No.: 17/519,791

(22) Filed: Nov. 5, 2021

Related U.S. Application Data
(60) Provisional application No. 63/110,048, filed on Nov. 5, 2020.

(51) Int. Cl. C12G 3/07

(52) U.S. Cl. CPC C12G 3/07

(57) ABSTRACT

The disclosure provides a method of producing a spirit that uses one or more wood pieces in the bottle with the spirit to enhance the flavor of the spirit. Instead of placing a spirit in a wood cask or barrel for adding flavor, a spirit is placed in a bottle and at least one wood piece is also placed in the bottle during manufacturing for enhancing the flavor of the spirit. In one example a method of producing an enhanced spirit includes: (1) placing a spirit in a bottle, (2) placing two or more wood pieces in the bottle, and (3) sealing the bottle, having located within the bottle both the spirit and the two or more wood pieces. Various physical attributes and wood processing of the wood pieces placed in the bottles can be selected for different enhancing results.

### CROSS-REFERENCE TO RELATED APPLICATION

This application claims the benefit of U.S. Provisional Application Ser. No. 63/110,048, filed by Joseph Giildenzopf on Nov. 5, 2020, entitled “A METHOD OF PRODUCING A SPIRIT USING ONE OR MORE WOOD PIECE FOR IN BOTTLE ENHANCING,” commonly assigned with this application and incorporated herein by reference in its entirety.

### TECHNICAL FIELD

This application is directed, in general, to producing spirits and, more specifically, to enhancing a flavor of a spirit.

### BACKGROUND

A distilled spirit, also referred to as a distilled beverage, liquor, hard liquor or hard alcohol, is an alcoholic beverage produced by distillation of fermented grains, fruit, or vegetables. Some distilled spirits, such as whiskey, bourbon, scotch, and rum, are aged after distillation. Aging is a process of storing the distilled spirits in wood barrels for an amount of time to add distinct flavors and remove harsh flavors from the raw alcohol. The wood barrels are typically constructed of toasted wood that interacts with the distilled spirit to contribute organic compounds and transforms acids into esters to give spirits their unique flavor.

The distilled spirit obtains distinct flavors from the different types of wood that are used for the barrels. In addition to distinct flavors, aging also adds color to the clear distilled spirits. The amount of time and the type of wood barrels can be specified for some distilled spirits. For example, all Scotch whisky must be aged in oak barrels for at least three years.

Once a distilled spirit is aged, it is typically removed from the wood barrel and bottled for distribution or later consumption. In contrast to wines, distilled spirits do not improve with age once placed in bottles. Instead, the maturation of the distilled spirit ends and the taste of the unopened whiskey, rum, etc. will not change while bottled and waiting to be opened.

### SUMMARY

In one aspect, a method of producing a spirit is disclosed. In one example, the method includes: (1) placing a spirit in a bottle, (2) placing one or more wood pieces in the bottle, wherein at least one of the one or more wood pieces has been rested in at least one resting agent, and (3) sealing the bottle, having located within the bottle both the spirit and the one or more wood pieces.

In another aspect, a method of producing an enhanced spirit is disclosed. In one example this method includes: (1) placing a spirit in a bottle, (2) placing two or more wood pieces in the bottle, and (3) sealing the bottle, having located within the bottle both the spirit and the two or more wood pieces.

In yet another aspect, the disclosure provides a sealed bottle of an enhanced spirit. In one example, the sealed bottle includes: (1) an intact seal, (2) a body, (3) a spirit contained within a volume defined by the body, and (4) two or more wood pieces located within the volume.

### BRIEF DESCRIPTION

Reference is now made to the following descriptions taken in conjunction with the accompanying drawings, in which:

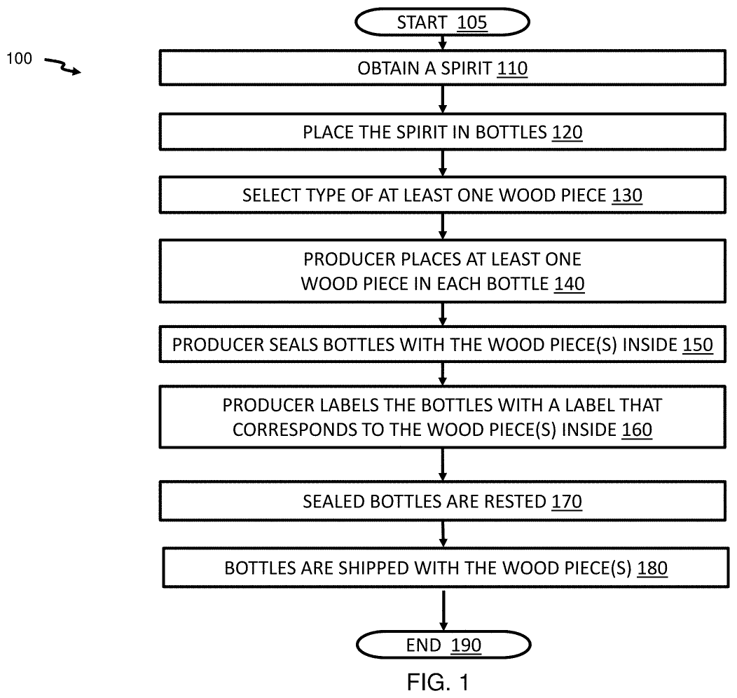

FIG. 1 illustrates a flow diagram of an example of a method of producing an enhanced spirit carried out according to the principles of the disclosure;

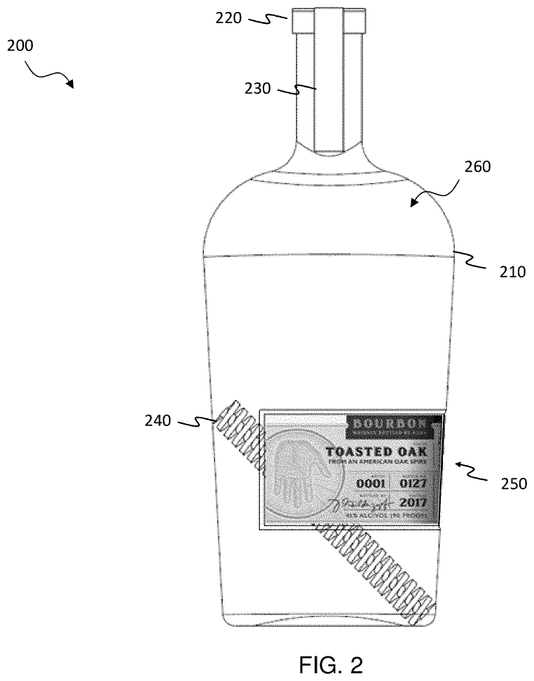

FIG. 2 illustrates a diagram of an example of a bottle of an enhanced spirit produced according to the principles of the disclosure;

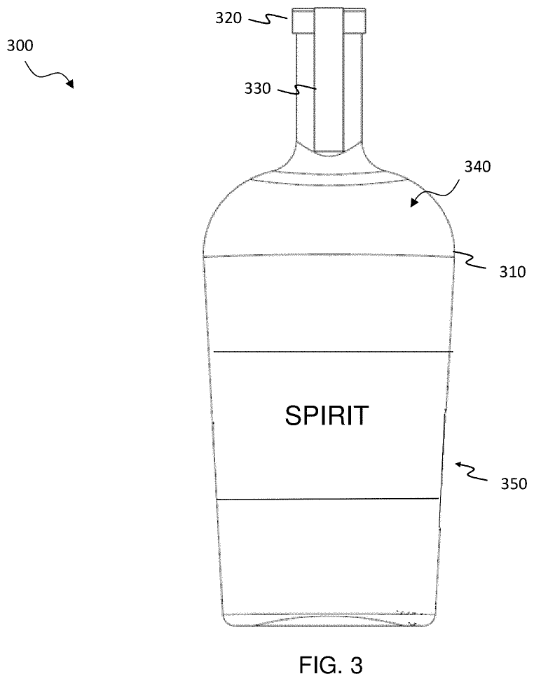

FIG. 3 illustrates an example of a bottle of an enhanced spirit having a wood piece that is an in-bottle label;

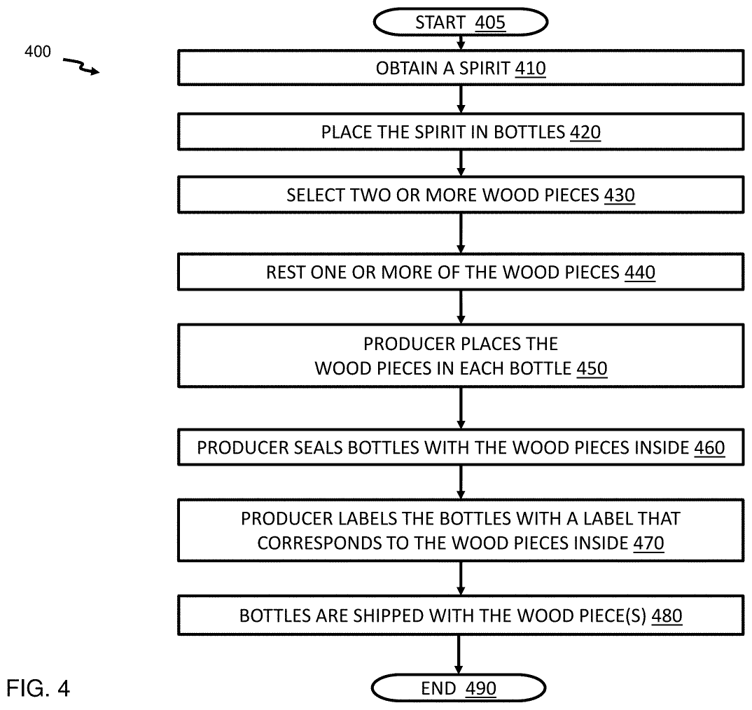

FIG. 4 illustrates a flow diagram of another example of a method of producing an enhanced spirit carried out according to the principles of the disclosure; and

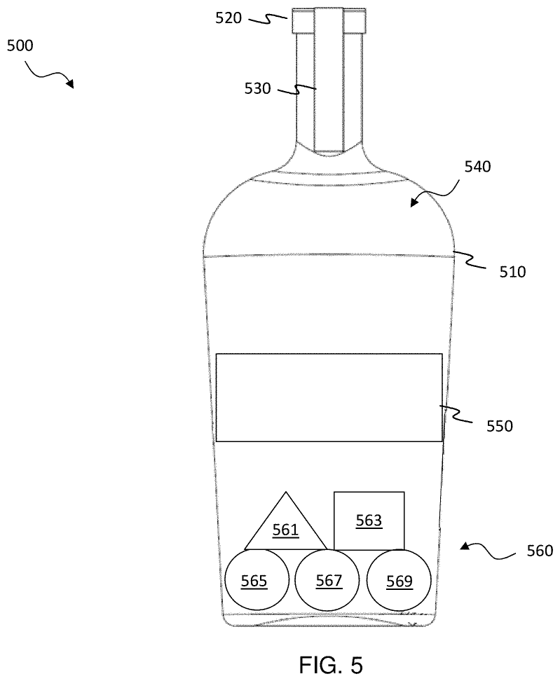

FIG. 5 illustrates an example of a bottle of a spirit having multiple wood pieces for enhancing according to the principles of the disclosure.

### DETAILED DESCRIPTION

Before being bottled, an additional processing step is sometimes used to add additional flavor to aged distilled spirits. This step, referred to as finishing, is a technique whereby aged spirits are placed in a secondary barrel or cask for further maturation. The secondary cask has most likely been used previously to age another spirit, like rum, brandy, wine, or beer. A finished spirit is sometimes referred to as double matured since the spirit is matured in a first cask (aging) and then matured in another cask (a second cask for finishing) of a different origin.

By placing the aged spirit in a secondary cask the spirit takes on new, more nuanced flavors from the wood and other elements that are inherent to the secondary cask. This “finishes” the spirit and makes it unique (sanctified). Unfortunately, finishing requires more time in addition to the time used for aging. As such, the cost and time for finishing can outweigh the benefit of a finished spirit. This can have a chilling effect on the development and delivery of new products to the market.

The disclosure provides a method of producing a spirit that uses one or more wood pieces in the bottle with the spirit to enhance the flavor of the spirit. Instead of placing a spirit in a wood cask or barrel for enhancing, the disclosed method includes placing a spirit in a bottle and enhancing the flavor of the spirit in the bottle employing at least one wood piece. For enhancing the spirit, one or more wood piece is placed in each of the bottles with the spirit during manufacturing before the bottle is sealed for commercial sale and distribution. Sealing as used herein refers to sealing a spirit in a bottle (such as a glass bottle) for commercial sale. Sealing can be performed according to industry standards and via a conventional method including, but not limited to, cork type closures, capsules (including spinning and shrinking), and screw-on caps. Once sealed, an intact seal is broken and the lid is removed by the purchaser/consumer of the bottled spirit.

The one or more wood piece in the bottle is used for further maturation or enhancing of the spirit in the bottle. For example, wood pieces can be used for finishing of an aged distilled spirit that is in the bottle. Thus, instead of in-cask finishing, the disclosed method advantageously employs in-bottle finishing. Additionally, one or more wood piece can be added to a bottle of a non-distilled spirit, such as wine or beer, to enhance the flavor of the non-distilled spirit. Each wood piece is produced to increase the interaction of the wood with the spirit in the bottle. As such, the amount of time for enhancing a spirit, such as finishing an aged distilled spirit compared to in-cask finishing, can be reduced.

Since part of the manufacturing process of the spirit includes using at least one wood piece, consistency of the wood pieces that are employed for enhancing is advantageous. Accordingly, the wood pieces can be produced according to certain parameters to produce a consistent finish across multiple bottles; including bottles having different volumes. In some examples, the wood pieces are selected to correspond to a particular time needed for enhancing the flavor. This also contributes to a consistent product for commercial sale.

The wood pieces can be cut to provide a high ratio of wood surface area to the spirit in a bottle. The wood pieces can be cut to provide an orientation of the wood grain to wood surface for an optimal wood-to-spirit in-bottle interaction. Accordingly, the surface area and grain orientation of each wood piece can be designed for in-bottle enhancing that can, for example, reduce finishing time compared to using a secondary cask. The design and production of the wood pieces allow the wood to impart desired chemical constituents into the bottled spirit while reacting and removing other chemical constituents (e.g., undesirable chemical constituents) from the bottled spirit in accordance with a known volume of the bottle and time used for enhancing. The wood pieces can be wood spires having a high surface area for chemical reaction with the spirit. In addition to the in-bottle interaction with a spirit, the surface area and grain orientation of the wood pieces is also pertinent when a wood piece is resting in a resting agent as noted below.

The wood pieces can also have other shapes, such as spheres, cones, cylinders, or a type of polyhedron. A non-limiting list of different types of polyhedrons that can be used include cubes, pyramids, cylinders, octahedron, dodecahedron, and icosahedron. Polyhedrons having a higher number of faces, for example an icosahedron compared to a pyramid, can have a higher surface area for chemical reaction with the spirit. The various shapes can also be modified such that the surface area of a wood piece is increased. For example, a face(s) or surface(s) of a wood piece can be notched, cut, scored, etc. to increase surface area that can be exposed to the spirit. One or more wood pieces of a first shape can be used with one or more wood pieces of a second different shape in a bottle. The amount of surface area of different wood pieces can also vary to provide different levels of interaction with a spirit. As such, a producer can control or at least influence the enhancing process using different surface areas of the wood pieces.

Various combinations of different shapes of wood pieces and different numbers of each shape can also be used in the same bottle. Non-limiting examples of multiple wood pieces placed in a single bottle of spirit include: a spire and a sphere; an octahedron, a pyramid, and a cube; a cylinder and two polyhedrons; and a cone, a cube and a spire. The different types of wood, shape, surface area, size, design, etc., are examples of the different physical attributes of a wood piece that can be selected for enhancing.

A wood piece can also be used as a label. The wood piece can be cut with label information and placed in the bottle. Thus, the wood piece can be used for in-bottle finishing and also function as a label. The wood piece for the label can be processed as the other example of wood pieces disclosed herein.

Turning now to the figures, FIG. 1 illustrates a flow diagram of an example of a method 100 of producing an enhanced spirit. The enhanced spirit can be a finished spirit, which is a distilled spirit that has been aged and then finished. The enhanced spirit can also be another type of spirit, distilled or not distilled. As such, the spirit that is enhanced can be a fermented spirit, a distilled spirit, or a fortified spirit such as a fortified wine. The method 100 provides sealed bottles of the spirit that includes at least one wood piece. The method 100 uniquely delivers reproducible flavor profiles to consumers employing at least one in-bottle wood piece. Each of the steps of the method 100 can be performed by a manufacturer as part of the commercial production of the bottled spirits. The method 100 begins in a step 105.

In a step 110, a spirit is obtained. The spirit can be a distilled spirit obtained from a producer as an already distilled product or can be produced via, for example, conventional methods. The distilled spirit can be a whisky, bourbon, rum, gin, tequila, etc. The distilled spirit can be aged. The distilled spirit can be aged by traditional methods such as placing it within wooden barrels for a designated amount of time. The amount of time can vary depending on the type of distilled spirit, different methods used (aging at sea, high altitudes, chemically controlled processes, etc.) or desired results. The spirit can be an aged distilled spirit that is obtained as an already aged distilled spirit. As noted above, the spirit can also be a fermented spirit, such as beer or wine, or a fortified spirit, such as a port.

The spirit is placed in bottles in a step 120. A conventional method of bottling according to the industry may be employed to place the spirit in bottles. As such, the bottles can be filled with the spirit according to industry standards. The bottles are the containers used for distributing the end product of the method 100. For example, the bottles in step 130 are the bottles that will later be sealed by the producer, distributed, and offered for sale. The bottle can have various shapes and sizes. Typically, the bottles are constructed of glass and have a sufficient opening to receive a wood piece as disclosed herein.

In a step 130, at least one wood piece is selected for placement in the bottles with the spirit. The types of wood pieces selected can correspond to a particular taste profile that is desired. Several different flavor factors can be selected to obtain a particular flavor profile. The taste profiles can vary by the type of wood of the wood piece and the type of wood processing, which is the amount of “toast and/or char” to which the wood is exposed. The types of wood include, but are not limited to, American oak, French oak, Cherry, Apple, Ash, and Mesquite. A wood piece can be cut from wood barrels that were previously used for aging of a distilled spirit or a non-distilled spirit, such as wine or beer. The wood piece can also be cut from wood barrels that were previously used for storing non-alcoholic products or liquids, such as tea, coffee, soft drinks, etc. The wood piece can also be selected from a type of wood that has not been actually used as part of a barrel or cask but is the type of wood that is typically used in one of the barrels. For example, an American oak wood piece can be selected that has not been part of a barrel but has been processed, such as toasted, to achieve a particular taste profile.

Toast levels are typically used to represent the amount of toast for the wood piece and are the degrees of heat to which the wood is exposed. The heat applied to the wood or wood piece molecularly changes the wood, causing it to release certain botanicals that are inherent in the wood. In some examples, the different toast levels are Light toast, Medium toast, and Heavy toast. The toast levels can correspond to industry standards.

Charring is a chemical process of incomplete combustion of the wood when subjected to high heat. Char levels are the degrees to which the wood or wood piece is exposed to fire. Like toasting, charring wood causes the wood to release different botanicals and flavor essences. Different Char levels is the time or duration that the wood is exposed to fire. In one example, the charring or Char levels that are used include Char 1, Char 2, and Char 3. The Char levels can correspond to industry standards.

A producer can mix and match the wood type, toast levels, and char levels to obtain different flavor profiles for the wood pieces. The producer can also use more than one wood piece and the multiple wood pieces can have a different one of one or more of a wood type, toast level, and/or char level. For example, one wood piece can be a medium toasted American oak with a char level of 1, and a second wood piece can be light toasted ash with a char level of 2. A combination of different shapes of wood pieces can also be used by the producer. The surface area or other physical attributes for the one or more of the different wood pieces can also be different to allow different influences on the spirit from the different wood pieces. Each of the various types of wood pieces can be constructed to provide reproducible flavor profiles. For example, by employing standard toast and char levels, a producer can create and deliver reproducible flavor profiles to consumers employing in-bottle enhancing. Employing a standard design, e.g., same dimensions and surface area, for the wood pieces also assists in delivering reproducible flavor profiles. For example, as noted above the wood pieces can be wood spires. To ensure the delivery of a consistent flavor profile the wood spires can be consistently cut a certain way. In some examples, the wood spires can be 5 inches in length (127 mm), ⅝ inches in diameter (15.875 mm), and cut in a spiral shape to expose more wood surface area. Similar construction consistency can be used for the other examples of wood pieces, also. For examples, spheres, cubes, pyramids, etc. can be reproducibly constructed.

The wood pieces can be cut to provide a desired ratio of the surface area to spirit volume within a bottle. Considering again a wood spire as an example, the surface area to volume ratio can be 467 mm² to 750 ml. Wood spires of different dimensions can be used for different sized bottles such that there is a consistent ratio of the wood surface area to the volume of spirits regardless the bottle size. In some examples, the surface area of the wood relative to the volume of spirit can be precisely determined to optimally enhance the spirit “in-bottle” within a designated amount of time. As such, the ratio of the surface area to volume ration can affect the amount of time for resting of sealed bottles, such as in step 170. For example, using a 750 ml bottle, the surface area to volume ratio can be the aforementioned 467 mm to 750 ml for an in-bottle finishing of six weeks. As noted above, the desired ratio of the surface area to spirit volume within a bottle can vary for different wood pieces in the same bottle.

In addition to the wood type, toast level, and char level, the wood pieces can also be rested in a resting agent before being place in a bottle to obtain or contribute to specific flavor profiles. The different type of liquids or non-liquids used for resting a wood piece are collectively referred to as resting agents. For example, before a wood piece is placed in the bottle of a spirit, depending on the taste profile that is desired, the wood piece, which can also be toasted or charred, may rest in a separate spirit, such as rum, brandy, wine or beer, to add yet another level of complexity to the enhanced spirit. Instead of a spirit, the wood piece can rest in a non-alcoholic product before being place in the bottle. For example, the wood piece can be rested in one or more of coffee, tea, a soft drink, honey, syrup, or another type of non-alcoholic liquid. The wood piece can also be rested in products that are not liquids (i.e., non-liquids), such as cinnamon, nutmeg, allspice, anise, vanilla, mint, or other types of spices. Floral products can also be used, including clover, hibiscus, honeysuckle, lavender, roses, etc. Fruit products, such as apple, orange or another type of citrus, or peach, is another example of non-liquid products that can be used for resting agents. The non-liquid products can be mixed with water or another type of liquid to create a liquid that can be used for the resting of the wood piece. One or more wood pieces can each be rested in different resting agents before being placed in the bottle. For example, a first spire can be rested in wine and a second spire can be rested in honey and both the first spire and the second spire can then be placed in the same bottle. Wood pieces of a particular shape can be rested in the same resting agent. For example, cubes can be rested in hibiscus and spheres can be rested in lavender. In some examples, the resting can produce wood pieces of different colors depending on, for example, the type of wood and the resting agent. For example, the spheres rested in lavender can have a purple color that is visible in a bottle of gin.

The amount of resting time can vary depending on empirical data for desired flavor profiles. At some point, absorption can be at least substantially reached where additional resting for a wood piece is not or only negligibly beneficial. The amount of resting time for the wood pieces can be, for example, six weeks and can vary depending on the type of wood piece and the resting agent. The ratio of surface area of a wood piece can also affect the resting of the wood piece in a resting agent before being placed in a bottle.

After selection of the one or more wood pieces, the selected one or more wood pieces is placed in the bottles by the producer in a step 140. One or more of the wood pieces can be placed in the bottles by hand or by machines. In some examples, multiple of a single type of the wood pieces can be placed in the bottles for a consistent reproducible enhancing. For example, a known or desired surface area to volume ratio of wood to spirit can be maintained when considering multiple pieces of the single type of wood. A different type of wood piece can be placed in different bottles. For example, a French Oak wood piece can be placed in some bottles and a charred oak wood piece can be placed in other bottles. Different wood types of wood pieces can be placed in a single bottle for a mixture of enhancing woods. Additionally, multiple wood pieces of the same wood type can be placed in bottles. Wood pieces of different shapes, wood types, char levels, toast levels, resting agents, and any combination thereof can be placed in the same bottle.

In a step 150, the bottles having the spirit and their one or more wood piece, are sealed. The bottles can be sealed via conventional procedures typically employed in the alcohol beverage industry. The producer seals the bottles with the one or more wood piece inside. Thus, the method 100 produces sealed bottles of a spirit having at least one wood piece within the sealed bottle. Each of the one or more wood pieces can be designed/cut/manufactured for a selected flavor profile for enhancing the spirit.

A label is added to the bottles in a step 160. The producer can attach labels to the bottles employing conventional methods known in the industry. Each of the labels can correspond to the type or types of wood pieces that is used for the enhancing. For example, a bottle can include bourbon and a wood piece that is toasted American oak. Accordingly, the label can include bourbon and note a toasted oak finish from an American oak wood piece, such as a spire. When the wood piece is rested in a resting agent, the label can also note the contribution of the resting to the flavor profile noted on the label. For example, when the wood piece is rested in coffee, the label can list the type of wood piece and indicate that the wood piece was rested in coffee. The label can also indicate the type of coffee and/or brewing process of the coffee used for resting, such as cold brew versus hot brew. When multiple wood pieces are in the bottle, the label can note the contribution of the combination of flavors. Thus, a consumer can know the type of in-bottle enhancing that is used with each bottle when purchased. When the wood piece, or at least one of the wood pieces, is also an in-bottle label, step 160 can happen with step 140. In addition to a wood piece being an in-bottle label, an additional label can also be added in step 160.

The sealed bottles with their at least one wood piece are then rested in a step 170 for a designated amount of time for finishing of the spirit. The amount of time can be based on empirical data and usually corresponds to the exhaustion or substantial exhaustion of the wood piece or pieces within the bottle. A wood piece is exhausted when it has imparted all or substantially all of the flavor that it can or is intended to impart to the surrounding spirit. Typically the designated amount of time for finishing is not changed to ensure consistent enhancing through multiple batches of production. The time for the enhancing, such as in-bottle finishing, corresponds to the completion of the exchange of chemical constituents between the wood piece and the bottled spirit. As such, the enhancing process, such as in-bottle finishing, disclosed herein is a function of the wood piece (design, size, production, type, toast, char, resting agent, etc.), liquid volume, and amount of time the sealed bottle is rested. The values of the variables of the enhancing process can be changed to provide the contribution of organic compounds to transform acids into esters to give the bottled spirits the desired unique flavor. In some examples, a taste test is used to determine a desired product taste and the combination and values of the variables used to provide the desired product taste are selected for manufacturing and consistent reproduction of the product.

Considering the wood spired discussed above as an example, once the spire is placed in-bottle, the bottle can be rested for six weeks before it is distributed or sold for consumption to allow sufficient time for the wood spire to enhance (sanctify) the spirit. As the finished product ages beyond six weeks, the flavor profiles typically will not change, but the product can become smoother and less harsh.

In a step 180, the bottles with at least one wood piece are shipped. At this point, the producer has completed the production process and the enhanced spirit is ready to be distributed and enjoyed by the consumer. The bottles can be shipped, for example, to retail stores, restaurants, or to end-users. For example, the sealed bottles can be purchased via a website by a customer and shipped directly to the customer. The method 100 ends in a step 190. One skilled in the art will understand that at least some of the steps of the method 100 can be performed in a different order than disclosed herein. For example, bottles can be labeled before adding the spirit and/or the at least one wood piece.

FIG. 2 illustrates an example of a bottle 200 of an enhanced spirit. The bottle 200 includes a body 210, a lid or cap 220, a seal 230, a wood piece 240, a label 250, and spirit 260 within a volume defined by the body 210. The bottle 200 is constructed of a non-permeable material. For example, the bottle 200 is made of a glass that is typically used for bottling liquor. The bottle 200 is an example of in-bottle enhancing of a spirit as disclosed herein and is ready for sale. Thus, the bottle 200 is ready to be, for example, placed on shelves or provided on websites for purchase by consumers.

The body 210 defines the shape and volume of the bottle 200. The body 210 has an inner and outer surface. The body 210 is collectively representing the base, heel, shoulder, etc., and other known parts of a bottle. As such, bodies of other shapes and volumes can also be used that differ from the representative body 210.

The lid 220 is used to cover the orifice of the bottle 200. The lid 220 can be a cork, a screw cap, or another type of lid that is, for example used in the industry.

The seal 230 is used to secure the lid 220 and indicate no tampering from the producer to the consumer. Instead of seal 230, other types of conventional seals can be used. As illustrated, the bottle 200 is capped, i.e., lid 220 put in place, and sealed after the wood piece 240 is placed in the bottle 200. Since the bottle 200 is for sale, the seal 230 is unbroken.

The wood piece 240 is placed in the bottle 200 before the lid 220 and the seal 230 are placed thereon. The wood piece 240 can be a spire as illustrated. As disclosed herein, the wood piece 240 can be designed to correspond to the volume of the bottle 200 and a desired finishing time. When first placed in the bottle 200 with the spirit 260, the wood piece 240 will float. The wood piece 240 absorbs the spirit 260 during the process of exchanging chemical constituents with the spirit 260 and sinks to the bottom of the bottle 200. In FIG. 2, the wood piece 240 is saturated with the spirit 260 and has sunk to the base of the bottle 200. The type of wood piece 240 in FIG. 2 is toasted oak from an American oak as denoted by the label 250.

The label 250 corresponds to the type of wood piece 240 within the bottle 200. The label 250 can be attached to the bottle 200 via a conventional procedure. The body 210 can include an indentation area (not identified in FIG. 2) that corresponds to a shape and size of the label 250 and the label 250 can be placed within the indentation section. The bottle 200 with lid 220, seal 230, wood piece 240, label 250 and spirit 260, is ready for a consumer and can be shipped for commercial distribution and sale. According to the label 250, the spirit 260 within the bottle 200 is a distilled spirit, bourbon. As noted herein, the disclosure covers other types of distilled spirits, such as tequila. Additionally, other types of spirits, such as wine, beer, or other spirits that are not distilled, may also be produced for sale having one or more wood piece within a sealed bottle. Also noted herein, the wood piece 240 can be rested in a resting agent before being placed in the bottle 200. The resting agent can be a spirit that is different than the spirit 260 or a non-alcoholic liquid. When the wood piece 240 is rested, the label 250 reflects the contribution of the resting to the flavor profile.

In one example, the bottle 200 has a volume of 750 ml and the wood piece 240 has the dimensions of 5 inches in length (127 mm), ⅝ inches in diameter (15.875 mm), and cut in a spiral shape to expose more wood surface area and provide a surface area to volume ratio of 467 mm to 750 ml for an in-bottle finishing of six weeks. The wood pieces can be infusion spirals commercially available from, for example, The Barrel Mill in Central Minnesota.

The bottle 200 includes a label, label 250, which is external to the bottle 200. An in-bottle label can also be used instead of or in addition to an external label. FIG. 3 illustrates a bottle with a wood piece as an in-bottle label.

FIG. 3 illustrates an example of a bottle 300 of a spirit having a wood piece that is an in-bottle label for enhancing. The bottle 300 includes a body 310, a lid or cap 320, a seal 330, a spirit 340, and an in-bottle wood label 350. The spirit 340 and the in-bottle wood label 350 are within a volume defined by the body 310. The bottle 300, lid 320, and seal 330 can correspond to similar items described herein, such as lid 220 and seal 230. The spirit 340 can be, for example, a fermented spirit, a distilled spirit, or a fortified spirit. The bottle 300 is ready to be sold, either wholesale or retail.

The wood label 350 can be cut with labeling info, rolled, and then pushed through the opening of the bottle 300. As such, the wood label 350 can be manipulated to be placed within the bottle 300. Once inside the bottle 300, the wood label 350 absorbs the spirit 340 and expands to fit within the body 310. The wood label 350 can also sink as it absorbs the spirit 340 to fit with the body 310 of the bottle 300. Accordingly, the wood label 350 is sized to fit through the opening when rolled (or folded) and fit within the body 310 when absorption is complete. As noted above, additional label information can be added to the outside of the bottle 300, also. Another wood piece or pieces can be included with the wood label 350. The wood label 350 can be processed and used for enhancing spirit 340 as other wood pieces disclosed herein are selected and used for enhancing, such as wood piece 240 of FIG. 2. For example, wood label 350 can be a light toasted oak, with a char level of 1, which was rested in a resting agent of syrup.

FIG. 4 illustrates a flow diagram of an example of a method 400 of producing an enhanced spirit. The method 400 provides sealed bottles of the spirit that includes two or more wood pieces. The method 400 uniquely delivers enhanced spirits to consumers employing in-bottle wood pieces. The enhanced spirits can include reproducible flavor profiles. Each of the steps of the method 400 can be performed by a manufacturer as part of a manufacturing process of bottling spirits for sale to consumers. The method 400 begins in a step 405.

In a step 410, a spirit is obtained. The spirit can be a fermented spirit, a distilled spirit, or fortified spirit. The spirit can be obtained as described above with respect to step 110 of FIG. 2. Other steps of method 400 that also correspond to steps of method 100 can be performed as similarly described with respect to method 100.

The spirit is placed in bottles in a step 420. A conventional method of bottling according to the industry may be employed to place the spirit in bottles. As such, the bottles can be filled with the spirit according to industry standards. The bottles are the containers used for distributing the end product of the method 400. For example, the bottles in step 420 are the bottles that will later be sealed by the producer and offered for sale for purchase by consumers. Typically, the bottles are constructed of glass and have a sufficient opening to receive a wood piece as disclosed herein. The bottles can have different shapes and different bottles can be used for different wood pieces. For example, when the wood piece is also an in-bottle label, the bottle can have a larger opening than bottles that receive other types of wood pieces, such as wood spires of spheres.

In a step 430, at least two wood pieces are selected for placement in the bottles with the spirit. The type of wood pieces selected can correspond to a particular taste profile that is desired. Several different flavor factors can be selected to obtain a particular flavor profile. The taste profiles can vary by the type of wood of the wood piece as discussed above.

A producer can select wood pieces that are the same or can mix and match the wood pieces to obtain different flavor profiles for the wood pieces. The multiple wood pieces can have a different one of one or more of a wood type, toast level, char level, shape, surface area, etc. As such, a combination of different shapes of wood pieces can be used by the producer and the surface area for the different wood pieces can also be different to allow different influences on the spirit in the bottle from the different wood pieces. Each of the various types of wood pieces can be constructed to provide reproducible flavor profiles in multiple bottles. As noted above, the desired ratio of the surface area to spirit volume within a bottle can vary with different wood pieces in the same bottle; this can also affect the resting of a wood piece.

In step 440, one or more of the wood pieces are rested in a resting agent. Each of the two or more selected wood pieces can be rested in a different resting agent or agents, or the same resting agent or agents. As noted above, the resting agent can be, for example, a type of spirit or non-alcoholic liquid. A spirit used for resting typically differs from the obtained spirit placed in the bottles. A wood piece can be rested in a first resting agent and then rested in one or more other resting agents. Additionally, different products can be combined to provide a resting agent. For example, a spirit can be combined with a non-spirit and the wood piece rested in the combination. Wood pieces of a particular shape can be rested in the same resting agent and can be used to add color to the wood pieces. The amount of resting time can vary due to the wood piece (e.g., shape, size, surface area) and resting agent. The resting of the wood pieces can be performed by another party instead of the producer. Accordingly, the producer can select wood pieces in step 430 that have already been rested. The producer can also perform additional resting in the same or another resting agent.

The two or more wood pieces are placed in each of the bottles by the producer in a step 450. The wood pieces can be placed in the bottles by hand or machinery can be used. Wood pieces of different shapes, wood types, char levels, toast levels, resting agents, and any combination thereof can be placed in the same bottle. FIG. 5 provides an example of different wood pieces in a bottle.

In a step 460, the bottles having the spirit and the two or more wood pieces are sealed. The bottles can be sealed via conventional procedures typically employed in the alcohol beverage industry. The producer seals the bottles with the two or more wood pieces inside. Thus, the method 400 produces sealed bottles of a spirit having at least two wood pieces designed/cut/manufactured for a selected flavor profile.

A label is added to the bottles in a step 470. The producer can attach labels to the bottles employing conventional methods known in the industry. When one of the two wood pieces is also an in-bottle label, labelling of the bottle can happen with step 450. In addition to a wood piece being an in-bottle label, an additional label can still be added in step 470.

In a step 480, the bottles with at least two wood pieces are shipped. At this point, the producer has completed the production process and the spirit is ready to be distributed and enjoyed by the consumer. The sealed bottles can be rested before being shipped. The method 400 ends in a step 490. One skilled in the art will understand that at least some of the steps of the method 400 can be performed in a different order than disclosed herein. For example, the wood pieces can be selected before adding the spirit to the bottles and/or the two or more wood pieces can be added to the bottles before adding the spirit.

FIG. 5 illustrates an example of a bottle 500 of a spirit having wood pieces for enhancing. The bottle 500 includes a body 510, a lid or cap 520, a seal 530, a spirit 540, a label 550 and wood pieces that are collectively referred to as wood pieces 560. The spirit 540 and the wood pieces 560 are within a volume defined by the body 510. The bottle 500 is constructed of a non-permeable material, such as glass, and is ready to be sold. Thus, the bottle 500 is ready, for example, to be displayed on shelves or a website for purchase by consumers.

The body 510 defines the shape and volume of the bottle 500. The body 510 has an inner and outer surface. The body 510 is collectively representing the base, heel, shoulder, etc., and other known parts of a bottle. Bottles having other bodies than illustrated by the representative body 510 can also be used. The lid 520 is used to cover the orifice of the bottle 500. The lid 520 can be a cork, a screw cap, or another type of lid that is conventionally used. The seal 530 is used to secure the lid 520 and indicate no tampering from the producer to the consumer. Seal 530 provides a visual example of a type of seal but other types of seals can be used according to industry standards. As illustrated, the bottle 500 is capped and sealed after the wood pieces 560 are placed in the bottle 500. Since the bottle 500 is for sale, the seal 530 is unbroken in FIG. 5.

The wood pieces 560 are placed in the bottle 500 before the lid 520 and the seal 530 are placed thereon. The wood pieces 560 include a pyramid 561, a cube 563, and spheres 565, 567, and 569. One of more of the wood pieces 560 can be different types of woods, with different toast levels, char levels, or neither no toast nor char. The surface area of one or more of the wood pieces 560 can also be different. One or more of the wood pieces 560 can also be rested wood pieces that have rested in a resting agent or agents before being placed in the bottle 500. A combination of the wood pieces 560 rested in different resting agents can be used. For example, the pyramid 561 can be rested in a first resting agent and the cube 563 can be rested in different resting agent. One or more of the spheres 565, 567, 569, can be rested in one of the same resting agents or yet in a third resting agent. Each of the spheres 565, 567, 569, can be rested in the same resting agent. The different wood pieces 560 can inherent a color from their resting agent that can provide a pleasing visual presentation in the bottle 500 along with the functional enhancing of the spirit 540. The wood pieces 560 can have other shapes than those shown in FIG. 5 and the number of wood pieces can vary. As disclosed herein, the wood pieces 560 can be designed to correspond to the volume of the bottle 500 and a desired time for enhancing the spirit. Typically when first placed in the bottle 500 with the spirit 540, the wood pieces 560 will float. The wood pieces 560 absorb the spirit 540 during the process of exchanging chemical constituents with the spirit 540 and sink to the bottom of the bottle 500. In FIG. 5, the wood pieces 560 are saturated with the spirit 540 and have sunk to the base of the bottle 500.

The label 550 corresponds to the type of wood pieces 560 within the bottle 500. The label 550 can be attached to the bottle 500 via a conventional procedure. The body 510 can include an indentation area (not identified in FIG. 5) that corresponds to a shape and size of the label 550 and the label 550 can be placed within the indentation section. The bottle 500 with lid 520, seal 530, spirit 540, label 550 and wood pieces 560, is ready for sale to consumers and can shipped for distribution and sale. When one or more of the wood pieces are rested, the label 550 reflects the contribution of the resting to the flavor profile.

Those skilled in the art to which this application relates will appreciate that other and further additions, deletions, substitutions and modifications may be made to the described examples.

What is claimed is:

1. A method of producing a spirit, comprising:
placing a spirit in a bottle;
placing one or more wood pieces in the bottle, wherein at least one of the one or more wood pieces has been rested in at least one resting agent; and
sealing the bottle, having located within the bottle both the spirit and the one or more wood pieces.

2. The method as recited in claim 1, wherein the one or more wood pieces has a shape of a sphere, a cone, a cylinder, or a type of polyhedron.

3. The method as recited in claim 1, wherein a particular shape of the one or more wood pieces is associated with a particular resting agent.

4. The method as recited in claim 1, wherein at least one of the one or more wood pieces has been rested in multiple resting agents.

5. The method as recited in claim 1, wherein the one or more wood pieces includes multiple wood pieces.

6. The method as recited in claim 5, wherein at least two of the multiple wood pieces have a different surface area.

7. The method as recited in claim 5, wherein at least two of the multiple wood pieces have a different shape.

8. The method as recited in claim 5, wherein at least two of the multiple wood pieces are a different wood type.

9. The method as recited in claim 5, wherein each of the multiple wood pieces are rested in a different resting agent.

10. The method as recited in claim 5, wherein at least two of the multiple wood pieces are rested in a different resting agent.

11. The method as recited in claim 10, wherein each of the different resting agents imbue a different color on the respective ones of the at least two of the multiple wood pieces.

12. The method as recited in claim 9, wherein at least one of the different resting agents is not a spirit.

13. The method as recited in claim 1, wherein the one or more wood pieces is an in-bottle label.

14. The method as recited in claim 13, further comprising placing a label on the bottle that is in addition to the in-bottle label.

15. The method as recited in claim 1, wherein the spirit is a fermented spirit, a distilled spirit, or a fortified spirit.

16. A method of producing an enhanced spirit, comprising:
placing a spirit in a bottle;
placing two or more wood pieces in the bottle; and
sealing the bottle, having located within the bottle both the spirit and the two or more wood pieces.

17. The method as recited in claim 16, wherein at least two of the two or more wood pieces have at least one different physical attribute.

18. The method as recited in claim 16, wherein at least two of the two or more wood pieces have a different wood processing.

19. The method as recited in claim 16, wherein at least one of the two or more wood pieces has been rested in at least one resting agent.

20. A sealed bottle of an enhanced spirit, comprising:
an intact seal;
a body;
a spirit contained within a volume defined by the body; and
two or more wood pieces located within the volume.
